(19) United States
(12) Patent Application Publication
(10) Pub. No.: US 2021/0284191 A1
(43) Pub. Date: Sep. 16, 2021

(54) AUTONOMOUS DRIVING USING LOCAL DRIVING PATTERNS

(71) Applicant: CARTICA AI LTD, Tel Aviv (IL)

(72) Inventors: Igal Raichelgauz, Tel Aviv (IL); Karina Odinaev, Tel Aviv (IL); Omer Jakobson, Tel Aviv (IL)

(73) Assignee: CARTICA AI LTD, Tel Aviv (IL)

(21) Appl. No.: 16/995,627

(22) Filed: Aug. 17, 2020

Related U.S. Application Data
(63) Continuation-in-part of application No. 16/815,032, filed on Mar. 11, 2020.

(51) Int. Cl. B60W 60/00; G06K 9/00; G06K 9/62; B60W 50/14; B60W 40/09; B60W 40/04

(52) U.S. Cl. CPC B60W 60/001; G06K 9/00791; G06K 9/6256; B60W 50/14; B60W 40/09; B60W 2554/404; B60W 2540/30; B60W 2555/60; B60W 2552/53; B60W 2554/80; B60W 40/04

(57) ABSTRACT

A method for driving a vehicle based on local driving patterns, the method may include receiving or generating local driving pattern information about driving patterns applied by different drivers at a certain location when facing different situations; when at the certain location, sensing a vicinity of the vehicle to provide sensed information; processing the sensed information to detect a current situation; determining, based on the local driving pattern information, at least one local driving pattern that should be applied when facing the current situations; and determining at least one driving scheme based on the at least one local driving pattern.

### CROSS REFERENCE

This application is a continuation-in-part (CIP) of PCT patent application PCT/IB2019/058207, filed Sep. 29, 2019, which claims the benefit of U.S. provisional application Nos. 62/747,147, filed Oct. 18, 2018; 62/750,822, filed Oct. 26, 2018; and 62/827,122, filed Mar. 31, 2019; and a continuation-in-part of U.S. patent application Ser. No. 6/542,327 filing date Aug. 16, 2019, which claims the benefit of 62/827,112, filed Mar. 31, 2019; and a continuation-in-part (CIP) of 16/815,032, filed Mar. 11, 2020, which is a continuation of PCT/IB2019/058207, filed Sep. 29, 2019; 16/815,032 also claims the benefit of 62/827,122, filed Mar. 31, 2019, all of which are hereby incorporated herein by reference.

### BACKGROUND

An autonomous driving system is expected to control, in the near future, an autonomous vehicle in an autonomous manner

An autonomous vehicle may be fed with an autonomous driving pattern that may not fit a current environment.

There is a growing need to provide a method, system and non-transitory computer readable medium for providing better autonomous driving patterns.

### SUMMARY

There may be provided a method for autonomous driving using local driving patterns.

### BRIEF DESCRIPTION OF THE DRAWINGS

The embodiments of the disclosure will be understood and appreciated more fully from the following detailed description, taken in conjunction with the drawings in which:

FIG. 1 illustrates an example of a method;

FIG. 2 is a partly-pictorial, partly-block diagram illustration of an exemplary obstacle detection and mapping system, constructed and operative in accordance with embodiments described herein;

FIG. 3 is a block diagram of an exemplary autonomous driving system to be integrated in the vehicle of FIG. 4;

FIG. 4 is a block diagram of a computerized system;

FIG. 5 illustrates an example of a method;

FIG. 6 illustrates an example of coarse contextual information;

FIG. 7 illustrates an example of coarse contextual information; and

FIG. 8 illustrates an example of a scenario.

### DESCRIPTION OF EXAMPLE EMBODIMENTS

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

Because the illustrated embodiments of the present invention may for the most part, be implemented using electronic components and circuits known to those skilled in the art, details will not be explained in any greater extent than that considered necessary as illustrated above, for the understanding and appreciation of the underlying concepts of the present invention and in order not to obfuscate or distract from the teachings of the present invention.

Any reference in the specification to a method should be applied mutatis mutandis to a device or system capable of executing the method and/or to a non-transitory computer readable medium that stores instructions for executing the method.

Any reference in the specification to a system or device should be applied mutatis mutandis to a method that may be executed by the system, and/or may be applied mutatis mutandis to non-transitory computer readable medium that stores instructions executable by the system.

Any reference in the specification to a non-transitory computer readable medium should be applied mutatis mutandis to a device or system capable of executing instructions stored in the non-transitory computer readable medium and/or may be applied mutatis mutandis to a method for executing the instructions.

Any combination of any module or unit listed in any of the figures, any part of the specification and/or any claims may be provided.

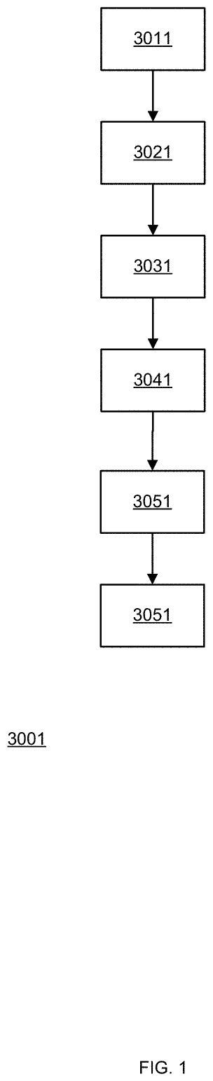

FIG. 1 illustrated method 3001 for driving a vehicle based on local driving patterns.

Method 3000 may be applied by a computerized system that is a remote computerized system (not located in a vehicle) or a computerized system located in one or more vehicle. For example—multiple vehicle computers located within multiple vehicles can participate in the execution of the method.

Method 3001 may start by step 3011 of receiving or generating local driving pattern information about driving patterns applied by different drivers at a certain location when facing different situations.

The local driving pattern information may be uploaded from a remote system, may be retrieved from a local memory of a vehicle, and the like.

The local driving pattern information may be indicative of at least one out of (a) a typical speed range of vehicles at the certain location, (b) a probability of trespassing of road segments at the certain location, (c) a typical distance between vehicles at the certain location, (d) an aggressiveness associated with local driving patterns at the certain location, (e) differences between driving patterns at the certain location, and (f) frequency of driving anomalies at the certain location, (g) calmness associated with local driving patterns at the certain location, and (h) predictability associated with local driving patterns at the certain location.

It may be beneficial to adopt a local driving pattern—as it may reduce the chances of accidents—as other road users are used to respond to the local driving pattern.

The local driving pattern is local in the sense that is may be applicable to a certain area. The area may cover at least a part of a neighborhood, at least a part of a city, at least a part of a town, at least a part of a district, at least a part of a countries, at least a part of a continent, at least a part of an island, one or more neighborhoods, one or more cities, one or more towns, one or more districts, one or more countries, one or more countries, one or more continents, and the like.

A situation may include one or more driving events, a combination of driving events and the presence (or absence) of one or more road users, a behavior patter of one or more road users, and the like.

A driving event may be a passage of an obstacle, a bypassing of an obstacle, driving at certain weather condition, driving in a curved section of a road, reacting to a presence of a zebra crossing, driving towards a crossroad, driving in a roundabout, a change in any driving parameter (acceleration, direction of propagation), turning the vehicle, bypassing a vehicle, parking, entering a scene that required a driver intervention, performing complex driving maneuvers, any driving event related to the driving that may cause a person within the vehicle to feel uncomfortable, and/or any combination of any one of the above. For example—a driving event may involve passing a bumper at a certain velocity, passing a bumper under a certain amount of rain, passing a bumper and entering a hole, and the like.

Various examples of a situation may be at least one of (a) a location of the vehicle, (b) one or more weather conditions, (c) one or more contextual parameters, (d) a road condition, (e) a traffic parameter.

Various examples of a road condition may include the roughness of the road, the maintenance level of the road, presence of potholes or other related road obstacles, whether the road is slippery, covered with snow or other particles.

Various examples of a traffic parameter and the one or more contextual parameters may include time (hour, day, period or year, certain hours at certain days, and the like), a traffic load, a distribution of vehicles on the road, the behavior of one or more vehicles (aggressive, calm, predictable, unpredictable, and the like), the presence of pedestrians near the road, the presence of pedestrians near the vehicle, the presence of pedestrians away from the vehicle, the behavior of the pedestrians (aggressive, calm, predictable, unpredictable, and the like), risk associated with driving within a vicinity of the vehicle, complexity associated with driving within of the vehicle, the presence (near the vehicle) of at least one out of a kindergarten, a school, a gathering of people, and the like. A contextual parameter may be related to the context of the sensed information- context may be depending on or relating to the circumstances that form the setting for an event, statement, or idea.

Step 3011 may be followed by step 3021 of sensing, when at the certain location, sensing a vicinity of the vehicle to provide sensed information.

The sensing may be executed by any sensor. The sensing may include sensing information that exceeds the vicinity of the vehicle—but at least the vicinity of the vehicle—for example up to few tens of meters and/or up to one or few hundred meters from the vehicle—especially at the direction of progress of the vehicle are sensed.

Step 3021 may be followed by step 3031 of processing the sensed information to detect a current situation.

Examples for detecting a situation are illustrated in U.S. patent Ser. No. 16/729,589 (attorney references COR-216) filing date Dec. 30, 2019 which is incorporated herein by reference.

Step 3031 may be followed by step 3041 of determining, based on the local driving pattern information, at least one local driving pattern that should be applied when facing the current situations.

Step 3041 may be followed by step 3051 of determining at least one driving scheme based on the at least one local driving pattern.

Step 3051 may be followed by step 3061 of responding to the determining

Step 3061 may include at least one out of:
Implementing the at least one driving scheme by an autonomous driving module of the vehicle. The driving scheme one applied will cause the autonomic vehicle to follow a local driving pattern that is adapted to the current situation.
Notifying the driver about the at least one driving scheme.
Notifying another road user about the at least one driving scheme.
Notifying a remote system about the at least one driving scheme.

It should be noted that step 3011 may include receiving or generating multiple local driving pattern information about driving patterns applied by different drivers at multiple locations when facing different situations. Other steps of method 3001 may be applied per each location.

The local driving pattern information may be of different formats. For example—the local driving pattern information may include at least one compact contextual signature of at least one sensed road user. An example of compact contextual signature is illustrated in U.S. patent application Ser. No. 16/815,032 filing date Sep. 27, 2019 (Attorney reference number COR-247) which is incorporated herein by reference.

A compact contextual signature of each road user of the at least one road user may include (a) coarse contextual metadata regarding the sensed road user, (b) coarse location information regarding the sensed road user, (c) identifiers of other sensed road users, and (d) coarse situation information.

In this case—step 3031 of processing of the sensed information may include generating compact contextual signatures of sensed road users within the vicinity of the vehicle; feeding the compact contextual signatures to a machine learning process trained to estimate behaviors of road users based on compact contextual signatures of road users; and predicting, by the machine learning process, the behaviors of the sensed road users.

The compact contextual signature of each sensed road user may consist essentially of (a) the coarse contextual metadata regarding the sensed road user, (b) the coarse location information regarding the sensed road user, (c) the identifiers of other sensed road users, and (d) the coarse situation information

The coarse location information may consists essentially of (a) a segment in which the road user is located, and (b) location of the road user within the segment.

The location information may reflect a location of the road user within the segment during a period that exceeds one second.

The coarse contextual metadata regarding the sensed road user may consist essentially of (a) a type of the road user, and (b) one or more motion related attributes.

The one or more motion related attribute may consist essentially of a movement indicator of the road user.

The coarse situation information may include environmental metadata that illustrates segments of the environment.

The environmental information may consist essentially of (a) segments coarse dimensional information, (b) segments orientation, (c) legal limitations information, and (d) exit information regarding allowable exit directions from segments.

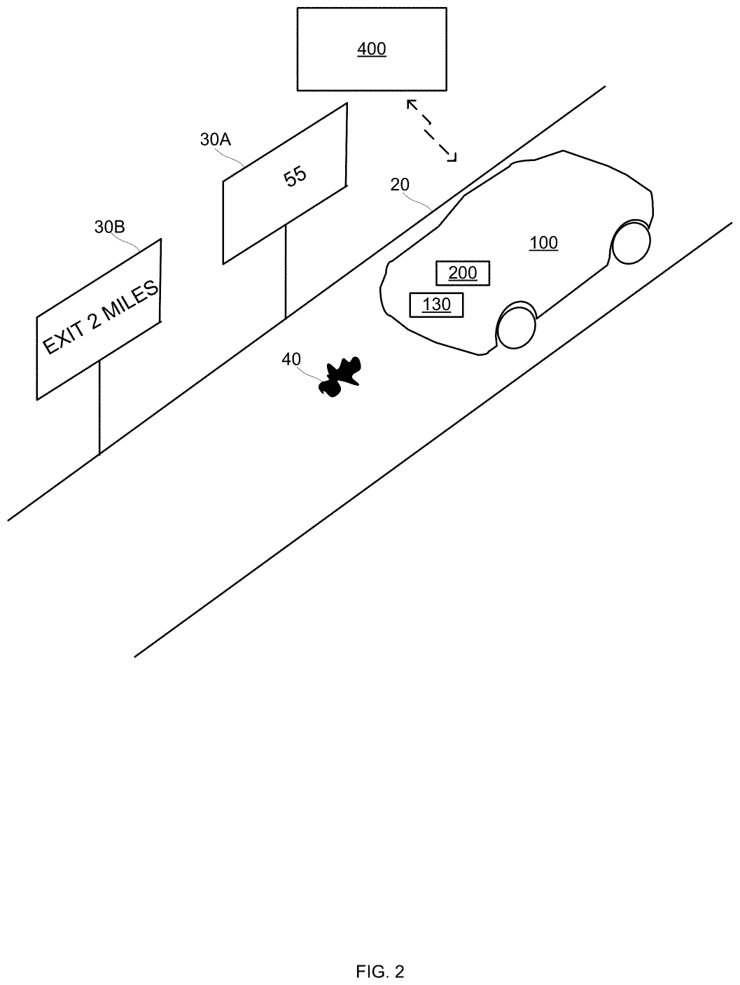

Reference is now made to FIG. 2, which is a partly-pictorial, partly-block diagram illustration of an exemplary system 10 constructed and operative in accordance with embodiments described herein.

System 10 comprises vehicle 100 and a remote computerized system such as remote computerized system 400 which may be configured to communicate with each other over a communications network such as, for example, the Internet.

In accordance with the exemplary embodiment of FIG. 2, vehicle 100 may be configured with an autonomous driving system 200 operative to autonomously provide driving instructions to vehicle 100 without the intervention of a human driver. It will be appreciated that the embodiments described herein may also support the configuration of vehicle 100 with an assisted (or “semi-autonomous”) driving system where in at least some situations a human driver may take control of vehicle 100 and/or where in at least some situations the semi-autonomous driving system provides warnings to the driver without necessarily directly controlling vehicle 100.

Vehicle 10 may execute method 3001.

In accordance with the exemplary embodiment of FIG. 2, vehicle 100 may be configured with at least one sensor 130 to provide information about a current driving environment as vehicle 100 proceeds along roadway 20. It will be appreciated that while sensor 130 is depicted in FIG. 2 as a single entity, in practice, as will be described hereinbelow, there may be multiple sensors 130 arrayed on, or inside of, vehicle 130. In accordance with embodiments described herein, sensor(s) 130 may be implemented using a conventional camera operative to capture images of roadway 20 and objects in its immediate vicinity. It will be appreciated that sensor 130 may be implemented using any suitable imaging technology instead of, or in addition to, a conventional camera. For example, sensor 130 may also be operative to use infrared, radar imagery, ultrasound, electro-optics, radiography, LIDAR (light detection and ranging), etc. Furthermore, in accordance with some embodiments, one or more sensors 130 may also be installed independently along roadway 20, where information from such sensors 130 may be provided to vehicle 100 and/or computerized system 400 as a service.

In accordance with the exemplary embodiment of FIG. 2, static reference points 30A and 30B (collectively referred to hereinafter as static reference points 30) may be located along roadway 20. For example, static reference point 30A is depicted as a speed limit sign, and static reference point 30B is depicted as an exit sign. In operation, sensor 130 may capture images of static reference points 30. The images may then be processed by the autonomous driving system in vehicle 100 to provide information about the current driving environment for vehicle 100, e.g., the speed limit or the location of an upcoming exit.

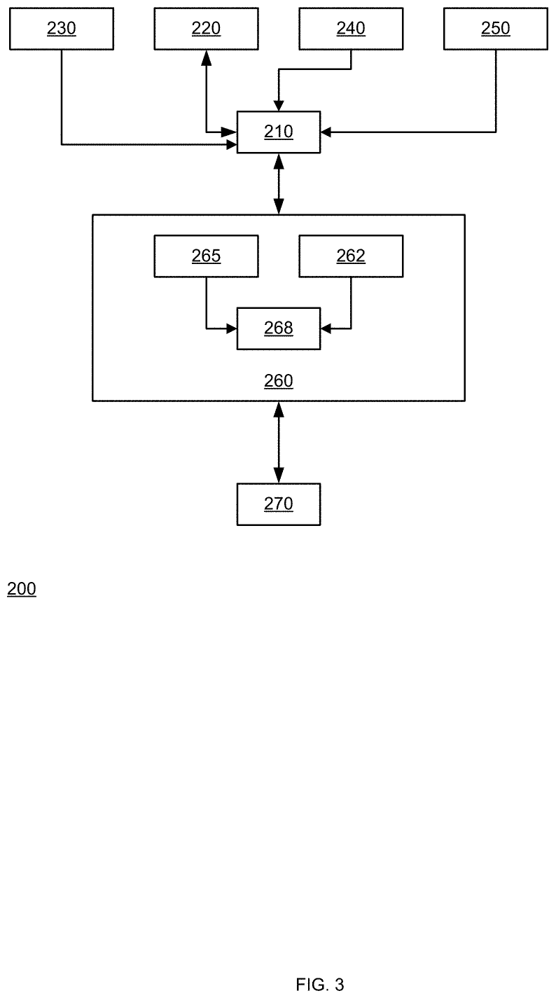

Reference is now made to FIG. 3 which is a block diagram of an exemplary autonomous driving system 200 (hereinafter also referred to as system 200), constructed and implemented in accordance with embodiments described herein.

Autonomous driving system 200 comprises processing circuitry 210, input/output (I/O) module 220, camera 230, telemetry ECU 240, shock sensor 250, autonomous driving manager 260, and database 270.

Autonomous driving manager 260 may be instantiated in a suitable memory for storing software such as, for example, an optical storage medium, a magnetic storage medium, an electronic storage medium, and/or a combination thereof. It will be appreciated that autonomous driving system 200 may be implemented as an integrated component of an onboard computer system in a vehicle, such as, for example, vehicle 100 from FIG. 2. Alternatively, system 200 may be implemented and a separate component in communication with the onboard computer system. It will also be appreciated that in the interests of clarity, while autonomous driving system 200 may comprise additional components and/or functionality e.g., for autonomous driving of vehicle 100, such additional components and/or functionality are not depicted in FIG. 2 and/or described herein.

Processing circuitry 210 may be operative to execute instructions stored in memory (not shown). For example, processing circuitry 210 may be operative to execute autonomous driving manager 260. It will be appreciated that processing circuitry 210 may be implemented as a central processing unit (CPU), and/or one or more other integrated circuits such as application-specific integrated circuits (ASICs), field programmable gate arrays (FPGAs), full-custom integrated circuits, etc., or a combination of such integrated circuits. It will similarly be appreciated that autonomous driving system 200 may comprise more than one instance of processing circuitry 210. For example, one such instance of processing circuitry 210 may be a special purpose processor operative to execute autonomous driving manager 260 to perform some, or all, of the functionality of autonomous driving system 200 as described herein.

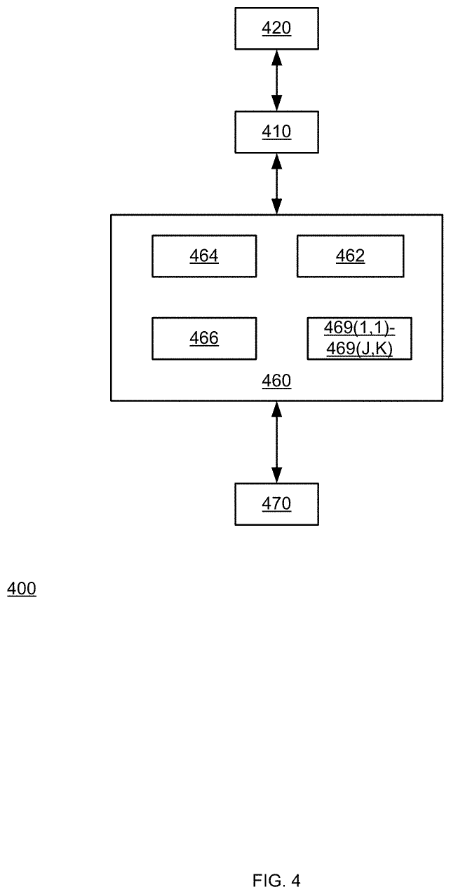

I/O module 220 may be any suitable communications component such as a network interface card, universal serial bus (USB) port, disk reader, modem or transceiver that may be operative to use protocols such as are known in the art to communicate either directly, or indirectly, with other elements of system 10 (FIG. 1) and/or system 200, such as, for example, computerized system 400 (FIG. 4), camera 230, telemetry ECU 240, and/or shock sensor 250. As such, I/O module 220 may be operative to use a wired or wireless connection to connect to computerized system 400 via a communications network such as a local area network, a backbone network and/or the Internet, etc. I/O module 220 may also be operative to use a wired or wireless connection to connect to other components of system 200, e.g., camera 230, telemetry ECU 240, and/or shock sensor 250. It will be appreciated that in operation I/O module 220 may be implemented as a multiplicity of modules, where different modules may be operative to use different communication technologies. For example, a module providing mobile network connectivity may be used to connect to computerized system 400, whereas a local area wired connection may be used to connect to camera 230, telemetry ECU 240, and/or shock sensor 250.

In accordance with embodiments described herein, camera 230, telemetry ECU 240, and shock sensor 250 represent implementations of sensor(s) 130 from FIG. 4. It will be appreciated that camera 230, telemetry ECU 240, and/or shock sensor 250 may be implemented as integrated components of vehicle 100 (FIG. 4) and may provide other functionality that is the interests of clarity is not explicitly described herein. As described hereinbelow, system 200 may use information about a current driving environment as received from camera 230, telemetry ECU 240, and/or shock sensor 250 to determine an appropriate driving policy for vehicle 100.

Autonomous driving manager 260 may be an application implemented in hardware, firmware, or software that may be executed by processing circuitry 210 to provide driving instructions to vehicle 100. For example, autonomous driving manager 260 may use images received from camera 230 and/or telemetry data received from telemetry ECU 240 to determine an appropriate driving policy for arriving at a given destination and provide driving instructions to vehicle 100 accordingly. It will be appreciated that autonomous driving manager 260 may also be operative to use other data sources when determining a driving policy, e.g., maps of potential routes, traffic congestion reports, etc.

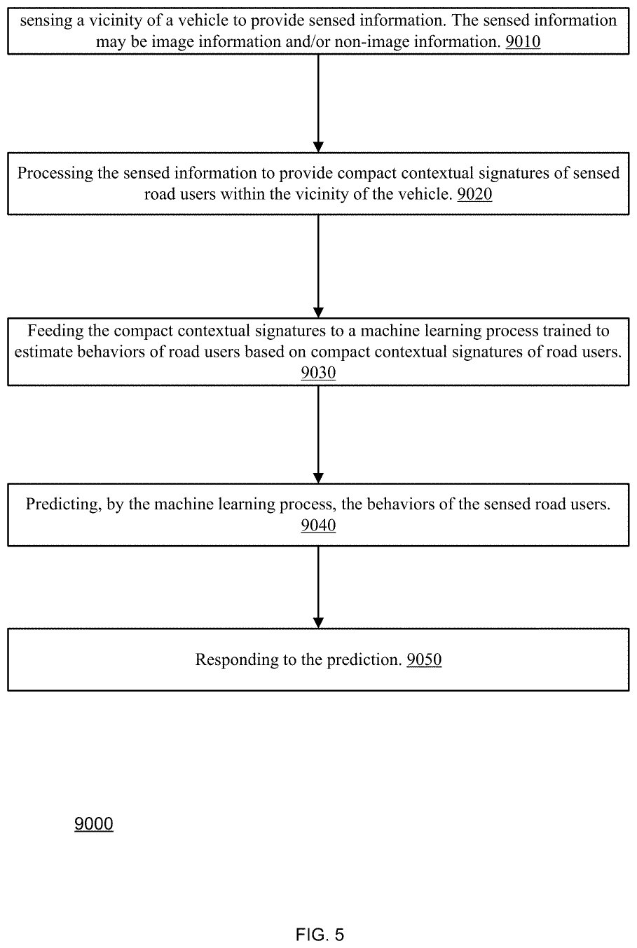

As depicted in FIG. 5, autonomous driving manager 260 comprises driving event detector 265 and autonomous driving pattern module 268. It will be appreciated that the depiction of driving event detector 265 and autonomous driving pattern module 268 as integrated components of autonomous driving manager 260 may be exemplary. The embodiments described herein may also support implementation of driving event detector 265 and autonomous driving pattern module 268 as independent applications in communication with autonomous driving manager 260, e.g., via I/O module 220.

Driving event detector 265 and autonomous driving pattern module 268 may be implemented in hardware, firmware, or software and may be invoked by autonomous driving manager 260 as necessary to provide input to the determination of an appropriate driving policy for vehicle 100. For example, driving event detector 265 may be operative to use information from sensor(s) 130 (FIG. 4), e.g., camera 230, telemetry ECU 240, and/or shock sensor 250 to detect or predict the future occurrence of a driving event in (or near) the driving path of vehicle 100, e.g., along (or near) roadway 20 (FIG. 4). Driving event detector may search for driving event indicators in order to the detect or predict the future occurrence of a driving event.

Autonomous driving pattern module 268 may be operative to determine an appropriate Local autonomous driving pattern to be applied when detecting a future occurrence of a driving event and to apply that Local autonomous driving pattern.

Depending on the configuration of system 100, the information from computerized system 400 may be received in a batch update process, either periodically and/or triggered by an driving event, e.g., when vehicle 100 is turned on, when vehicle 100 enters a new map area, when vehicle 100 enters an area with good wireless reception, etc.

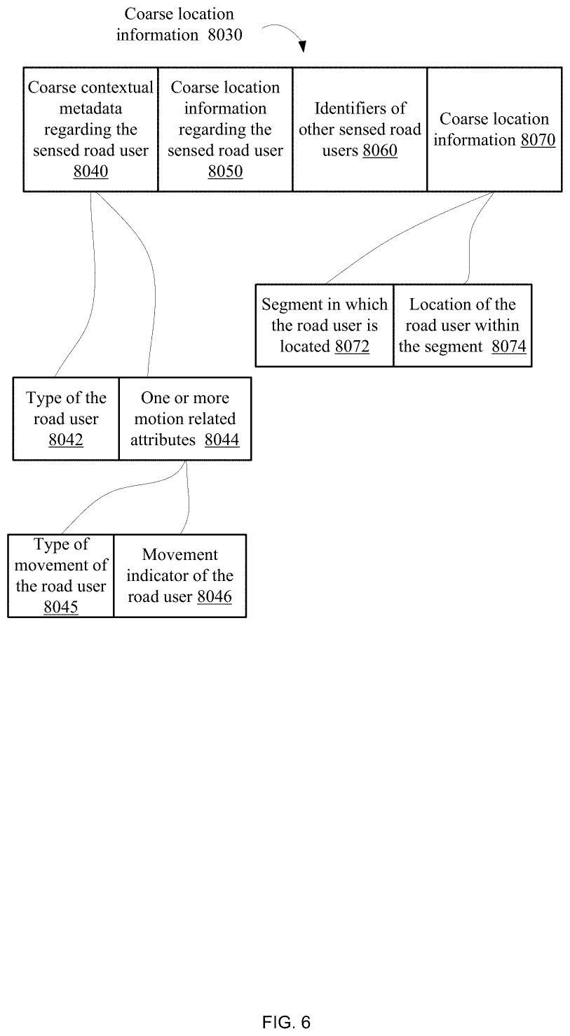

Reference is now made to FIG. 6 which is a block diagram of a computerized system 400 (hereinafter also referred to as computerized system 400), constructed and implemented in accordance with embodiments described herein.

Computerized system 400 comprises processing circuitry 410, input/output (I/O) module 420, Local autonomous driving pattern manager 460, and database 470. Local autonomous driving pattern manager 460 may be instantiated in a suitable memory for storing software such as, for example, an optical storage medium, a magnetic storage medium, an electronic storage medium, and/or a combination thereof.

Processing circuitry 410 may be operative to execute instructions stored in memory (not shown). For example, processing circuitry 410 may be operative to execute Local autonomous driving pattern manager 460. It will be appreciated that processing circuitry 410 may be implemented as a central processing unit (CPU), and/or one or more other integrated circuits such as application-specific integrated circuits (ASICs), field programmable gate arrays (FPGAs), full-custom integrated circuits, etc., or a combination of such integrated circuits. It will similarly be appreciated that computerized system 400 may comprise more than one instance of processing circuitry 410. For example, one such instance of processing circuitry 410 may be a special purpose processor operative to execute the Local autonomous driving pattern manager 460 to perform some, or all, of the functionality of computerized system 400 as described herein.

I/O module 420 may be any suitable communications component such as a network interface card, universal serial bus (USB) port, disk reader, modem or transceiver that may be operative to use protocols such as are known in the art to communicate either directly, or indirectly, with other elements of system 10 (FIG. 4) such as, for example, system 200 (FIG. 5). As such, I/O module 420 may be operative to use a wired or wireless connection to connect to system 200 via a communications network such as a local area network, a backbone network and/or the Internet, etc. It will be appreciated that in operation I/O module 220 may be implemented as a multiplicity of modules, where different modules may be operative to use different communication technologies. For example, a module providing mobile network connectivity may be used to connect wirelessly to one instance of system 200, e.g., one vehicle 100 (FIG. 4), whereas a local area wired connection may be used to connect to a different instance of system 100, e.g., a different vehicle 100.

Local autonomous driving pattern manager 460 may be an application implemented in hardware, firmware, or software that may be executed by processing circuitry 410 to provide driving event identifiers and tailored Local autonomous driving pattern information for each one of the multiple types of driving events.

As depicted in FIG. 4, autonomous driving pattern manager 460 may include situation detector 462, local driving pattern provider 464, and responding unit 466. FIG. 4 also illustrates a memory unit that stores local driving pattern information associated with different scenarios and with one or more locations—469(1,1)-469(J,K). J and K being positive integers.

It will be appreciated that the situation detector 462, local driving pattern provider 464, and responding unit 466 as integrated components of autonomous driving pattern manager 460 may be exemplary. The embodiments described herein may also support implementation of situation detector 462, local driving pattern provider 464, and responding unit 466 as independent applications in communication with autonomous driving pattern manager 460, e.g., via I/O module 420.

Situation detector 462, local driving pattern provider 464, and responding unit 466 may be implemented in hardware, firmware, or software and may be invoked by autonomous driving pattern manager 460 as necessary to provide obstacle warnings and associated driving policies to vehicles 100.

Situation detector 462 may detect a current situation.

Local driving pattern provider 464 may select or otherwise generate a local driving pattern to be applied when facing the current situation (at the location of the vehicle). Responding unit 464 may respond to the determination of local driving pattern to be applied when facing the current situation.

### COMPACT REPRESENTATION OF THE BEHAVIOR OF ROAD USERS

It has been found that the resolution of the sensory information and the accuracy of the costly process may well exceed the resolution required for making decisions regarding a driving of a vehicle at the presence of the road users.

There is provided a compact representation of the behavior of road users. The compact representation may assist in predicting the behavior of the road users.

The prediction may assist in determining a manner in which a vehicle may autonomously drive in the presence of the road users, may assist to determine a suggested manner in which a vehicle will partially autonomously drive in the presence of the road users, and/or may assist in determining a suggested manner in which a human driver should drive at the presence of the road users, and the like.

A partially autonomous driving may include performing without driver intervention only one or some aspects of the driving—for example maintaining lane, emergency breaking and the like.

The compact representation is coarse—has a lower and even much lower resolution that the resolution of high resolution sensors of the vehicle, and thus does not consume large memory resources, can be easily processed and can be easily communicated.

FIG. 5 illustrates a method 9000 for predicting behaviors of sensed road users. A rod user may be any human or device (vehicle) that uses the road or a vicinity of the road (for example—sidewalk). Uses the road may mean moving on the road or the vicinity of the road, being positioned (static or dynamic) on the road or within the vicinity of the road, and the like.

Method 9000 may include step 9010 of sensing a vicinity of a vehicle to provide sensed information. The sensed information may be image information and/or non-image information. The sensing may be done by one or more vehicle sensors. The sensors may be passive (for example, a camera) and/or active (a radar, a LIDAR, a sonar, and the like).

The vicinity of the vehicle may include any area that is within one or more fields of view of the one or more vehicle sensors. The sensing may include sensing (in addition to the vicinity of the vehicle) additional areas that are located far away from the vehicle. The vicinity of the vehicle may be within few tens of meters from the vehicle, up to one hundred meters from the vehicle, and the like.

Step 9010 may be followed by step 9020 of processing the sensed information to provide compact contextual signatures of sensed road users within the vicinity of the vehicle.

The processing may include object detection. Examples of object detection can be found in PCT/IB2019/058207 filing date Sep. 27, 2019, in U.S. provisional Ser. No. 62/747,147 filing date Oct. 18, 2018 and in U.S. provisional patent Ser. No. 62/827,112—all being incorporated herein by reference. Other object detection methods may be used.

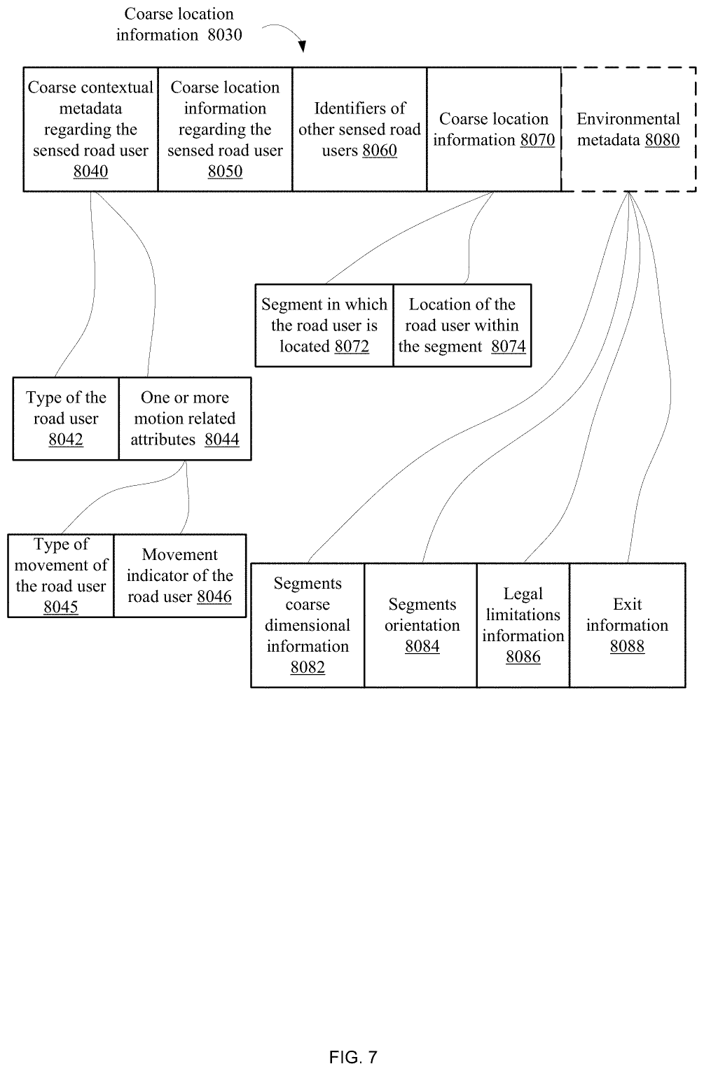

The object detection may be followed by generating the compact contextual signatures based on the object detection. An example of a compact contextual signature 8730 of a road user is illustrated in FIGS. 6 and 7.

The compact contextual signature 8730 (of each a sensed road user may include, may consists of, or may consist essentially of (a) coarse contextual metadata 8740 regarding the sensed road user, (b) coarse location information 8750 regarding the sensed road user, (c) identifiers 8760 of other sensed road users, and (d) coarse situation information 8770.

The coarse situation information 8770 may include, for example a situation index (for example—straight lane, junction, curb), type of surroundings (urban, highway, mountain road), type of path (paved road, unpaved path), lanes (including number, direction of driving in lane), and the like.

The identifiers of other sensed road users may include all sensed road users, only some (for example up to a predefined number—for example up to 10 or any other predefined value) of the road users, the closest road users, and the like.

The term coarse means at a resolution and/or accuracy and/or size of coarse that is lower than the corresponding resolution and/or accuracy and/or size of the sensed information.

The coarse location information 8750 may include, may consists of, or may consist essentially of (a) a segment in which the road user is located 8752, and (b) location of the road user within the segment 8754. The location within the segments may represent locations within a period of one or few seconds. The location can be stated as spatial relationship from a known part of the segment (center, corner, border, and the like).

The coarse location information 8750 may reflect a location of the road user within the segment during a period that exceeds one second.

The coarse contextual metadata regarding the sensed road user 8740 may include, may consists of, or may consist essentially of consists essentially of (a) a type of the road user 8742 (for example—pedestrian, child, grown-up, vehicle, car, truck, motorcycle, scooter, bicycle, vehicle model, vehicle manufacturer, vehicle year of manufacturing) and (b) one or more motion related attributes 8744.

The one or more motion related attribute 8744 may include, may consists of, or may consist essentially of a movement indicator of the road user 8746. The movement indicator may be a visible or otherwise perceivable indicator that may indicate the current or intended progress of the road user—for example winker light, breaking light and the like.

FIG. 7 illustrates that the coarse situation information may also include environmental metadata 8787 that illustrates segments of the environment.

The environmental metadata may include, may consists of, or may consist essentially of (a) segments coarse dimensional information 8782 (such as length, width), (b) segments orientation (direction of straight segment, direction of last part of a curved segment) 8784, (c) legal limitations information 8786 (for example allowed direction of driving, speed limit, vehicle permitted or forbidden (for example preventing trucks of a certain weight to drive through one or more segments during certain time period), and (d) exit information 8788 regarding allowable exit directions from segments (right, left, straight).

The coarse situation information may be converted to a numeral representation (for example—a high-dimensional vector such as a feature vector in which different parts of the coarse situation information are represented by different dimensions and/or different elements of the vector).

The numerical representation may be used in machine learning training and/or inference phases. The training process may include feeding the machine learning process sensed information acquired during one or multiple periods that are indicative of the behaviors of roads users in different situations. The training may include supervised or unsupervised learning. The training may include generating coarse situation information regarding the road users, monitoring the behaviors of the road users and providing a machine learning process that maps the coarse situation information to predicted behaviors.

Referring back to FIG. 5—Step 9020 may be followed by step 9030 of feeding the compact contextual signatures to a machine learning process trained to estimate behaviors of road users based on compact contextual signatures of road users.

Step 9030 may be followed by step 9040 predicting, by the machine learning process, the behaviors of the sensed road users.

The behaviors can be classified to classes, and the predicting may include selecting one or more classes based on the trained machine learning process.

Examples of behaviors are listed below:

When a car is approaching T-Junction—the behavior may be proceeding to any branch of the T-junction.

When a pedestrian is moving on a sidewalk—the behavior may be selected out of proceeding along the sidewalk, crossing the road or waiting on the sidewalk.

When a car is driving on a straight road—the behavior may be selected out of driving within the current lane, changing a lane, pulling over, and bypassing an obstacle.

Step 9040 may be followed by step 9050 of responding to the prediction.

The responding may include at least one out of determining a manner in which a vehicle may autonomously drive in the presence of the road users, determining a suggested manner in which a vehicle will partially autonomously drive in the presence of the road users, determining a suggested manner in which a human driver should drive at the presence of the road users, and following the determining.

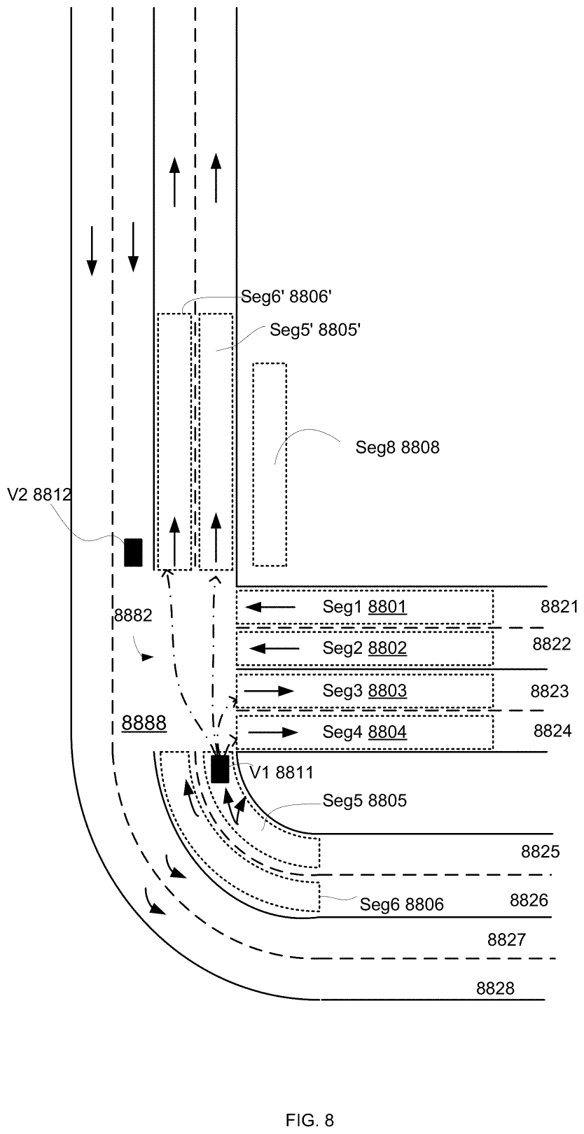

FIG. 8 illustrates a first bi-directional four-lane road that include four lanes—two lanes per direction—8821 and 8822, 8823 and 8824. The first bi-directional four-lane road has an east-west part, a curved part and a south-north part. FIG. 6 illustrates two curved segments (Seg5 8805 and Seg6 8806) formed in the curved part of lanes 8825 and 8826, and two straight segments (Seg5′ 8805′ and Seg6′ 8806′) formed in the south-north part. It should be noted that the entire first bi-directional four-lane road may be virtually segmented.

FIG. 8 also illustrates a second bi-directional four-lane road that include four lanes—two lanes per direction—8825 and 8826, 8827 and 8828. The second bi-directional four-lane road has an east-west part. FIG. 6 illustrates four east-west segments (Seg1 8801, Seg2 8802, Seg3 8803 and Seg4 8804).

The arrows in each one of the segments of FIG. 8 illustrate either allowed direction when entering the segments or allowable exit direction when exiting the segment.

FIG. 8 also illustrates a first vehicle V1 8811 and a second vehicle V2 8812. First vehicle V1 8811 is located near the upper border of Seg5 8805 and is about to cross the junction 8888. Assuming that the first vehicle V12 8811 applies method 7000 then it has to determine how to processed (possible propagation directions are denoted 8882), based on the coarse situation information.

The two first bi-directional four-lane road intersect to form junction 8888.

In any of the methods any of the autonomous driving pattern related to The driving event may be amended based on feedback provided by users of the vehicle.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention as claimed.

In the foregoing specification, the invention has been described with reference to specific examples of embodiments of the invention. It will, however, be evident that various modifications and changes may be made therein without departing from the broader spirit and scope of the invention as set forth in the appended claims.

Moreover, the terms “front,” “back,” “top,” “bottom,” “over,” “under” and the like in the description and in the claims, if any, are used for descriptive purposes and not necessarily for describing permanent relative positions. It is understood that the terms so used are interchangeable under appropriate circumstances such that the embodiments of the invention described herein are, for example, capable of operation in other orientations than those illustrated or otherwise described herein.

Furthermore, the terms “assert” or “set” and “negate” (or “deassert” or “clear”) are used herein when referring to the rendering of a signal, status bit, or similar apparatus into its logically true or logically false state, respectively. If the logically true state is a logic level one, the logically false state is a logic level zero. And if the logically true state is a logic level zero, the logically false state is a logic level one.

Those skilled in the art will recognize that the boundaries between logic blocks are merely illustrative and that alternative embodiments may merge logic blocks or circuit elements or impose an alternate decomposition of functionality upon various logic blocks or circuit elements. Thus, it is to be understood that the architectures depicted herein are merely exemplary, and that in fact many other architectures may be implemented which achieve the same functionality.

Any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermedial components. Likewise, any two components so associated can also be viewed as being “operably connected,” or “operably coupled,” to each other to achieve the desired functionality.

Furthermore, those skilled in the art will recognize that boundaries between the above described operations merely illustrative. The multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments.

Also for example, in one embodiment, the illustrated examples may be implemented as circuitry located on a single integrated circuit or within a same device. Alternatively, the examples may be implemented as any number of separate integrated circuits or separate devices interconnected with each other in a suitable manner

However, other modifications, variations and alternatives are also possible. The specifications and drawings are, accordingly, to be regarded in an illustrative rather than in a restrictive sense.

In the claims, any reference signs placed between parentheses shall not be construed as limiting the claim. The word ‘comprising’ does not exclude the presence of other elements or steps then those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

It is appreciated that various features of the embodiments of the disclosure which are, for clarity, described in the contexts of separate embodiments may also be provided in combination in a single embodiment. Conversely, various features of the embodiments of the disclosure which are, for brevity, described in the context of a single embodiment may also be provided separately or in any suitable sub-combination.

It will be appreciated by persons skilled in the art that the embodiments of the disclosure are not limited by what has been particularly shown and described hereinabove. Rather the scope of the embodiments of the disclosure is defined by the appended claims and equivalents thereof.

What is claimed is:

1. A method for driving a vehicle based on local driving patterns, the method comprises:
receiving or generating local driving pattern information about driving patterns applied by different drivers at a certain location when facing different situations;
when at the certain location, sensing a vicinity of the vehicle to provide sensed information;
processing the sensed information to detect a current situation;
determining, based on the local driving pattern information, at least one local driving pattern that should be applied when facing the current situations; and
determining at least one driving scheme based on the at least one local driving pattern.

2. The method according to claim 1 wherein the determining of the at least one driving scheme is followed by implementing the at least one driving scheme by an autonomous driving module of the vehicle.

3. The method according to claim 1 wherein the determining of the at least one driving scheme is followed by notifying the driver about the at least one driving scheme.

4. The method according to claim 1 wherein the local driving pattern information is about driving patterns applied by different drivers at each of multiple locations when facing different scenes; wherein the multiple locations comprise the certain location; and wherein the method comprises:
determining a current location of the multiple location in which the vehicle is located;
when in the current location, sensing the vicinity of the vehicle to provide sensed information;
processing the sensed information to detect the current scene;
determining, based on local driving pattern information related to the current location, at least one local driving pattern that should be applied when facing the current scene; and
determining at least one driving scheme based on the at least one local driving pattern.

5. The method according to claim 1 wherein the local driving pattern information is indicative of a typical speed range of vehicles at the certain location.

6. The method according to claim 1 wherein the local driving pattern information is indicative of probability of trespassing of road segments at the certain location.

7. The method according to claim 1 wherein the local driving pattern information is indicative of a typical distance between vehicles at the certain location.

8. The method according to claim 1 wherein the local driving pattern information is indicative of an aggressiveness associated with local driving patterns at the certain location.

9. The method according to claim 1 wherein the local driving pattern information is indicative of differences between driving patterns at the certain location.

10. The method according to claim 1 wherein the local driving pattern information is indicative of frequency of driving anomalies at the certain location.

11. The method according to claim 1 wherein the local driving pattern information comprises at least one compact contextual signature of at least one sensed road user;
wherein a compact contextual signature of each road user of the at least one road user comprises (a) coarse contextual metadata regarding the sensed road user, (b) coarse location information regarding the sensed road user, (c) identifiers of other sensed road users, and (d) coarse situation information.

12. The method according to claim 11 wherein the processing of the sensed information comprises: generating compact contextual signatures of sensed road users within the vicinity of the vehicle; feeding the compact contextual signatures to a machine learning process trained to estimate behaviors of road users based on compact contextual signatures of road users; and predicting, by the machine learning process, the behaviors of the sensed road users.

13. The method according to claim 12 wherein the compact contextual signature of each sensed road user consists essentially of (a) the coarse contextual metadata regarding the sensed road user, (b) the coarse location information regarding the sensed road user, (c) the identifiers of other sensed road users, and (d) the coarse situation information.

14. The method according to claim 13 wherein the coarse location information consists essentially of (a) a segment in which the road user is located, and (b) location of the road user within the segment.

15. The method according to claim 14 wherein the location information reflects a location of the road user within the segment during a period that exceeds one second.

16. The method according to claim 13 wherein the coarse contextual metadata regarding the sensed road user consists essentially of (a) a type of the road user, and (b) one or more motion related attributes.

17. The method according to claim 16 wherein the one or more motion related attribute consists essentially of a movement indicator of the road user.

18. The method according to claim 16 wherein the coarse situation information comprises environmental metadata that illustrates segments of the environment.

19. The method according to claim 18 wherein the environmental information consists essentially of (a) segments coarse dimensional information, (b) segments orientation, (c) legal limitations information, and (d) exit information regarding allowable exit directions from segments.

20. A non-transitory computer readable medium for driving a vehicle based on local driving patterns, the non-transitory computer readable medium stores instructions for:
receiving or generating local driving pattern information about driving patterns applied by different drivers at a certain location when facing different situations;
when at the certain location, sensing a vicinity of the vehicle to provide sensed information;
processing the sensed information to detect a current situation;
determining, based on the local driving pattern information, at least one local driving pattern that should be applied when facing the current situations; and
determining at least one driving scheme based on the at least one local driving pattern.
